(19) United States
(12) Patent Application Publication
(10) Pub. No.: US 2024/0139708 A1
(43) Pub. Date: May 2, 2024

(54) NONWOVEN HEMP HURD-BASED MATERIALS

(71) Applicant: Thomas Jefferson University, Philadelphia, PA (US)

(72) Inventor: Brian R. George, Philadelphia, PA (US)

(21) Appl. No.: 15/733,794

(22) PCT Filed: Apr. 26, 2019
(86) PCT No.: PCT/US2019/029426

§ 371 Date: Sep. 23, 2021

Related U.S. Application Data
(60) Provisional application No. 62/663,693, filed on Apr. 27, 2018.

(51) Int. Cl. B01J 20/24; B01J 20/26; B01J 20/28; B01J 20/30; D04H 1/407; D04H 1/425; D04H 1/4382; D04H 1/64; D04H 1/732; D21F 11/00; D21H 11/12; D21H 17/33; D21H 21/22; D21H 27/00; D21H 27/30

(52) U.S. Cl. CPC B01J 20/24; B01J 20/26; B01J 20/2803; B01J 20/28035; B01J 20/3042; D04H 1/407; D04H 1/425; D04H 1/43835; D04H 1/64; D04H 1/732; D21F 11/00; D21H 11/12; D21H 17/33; D21H 21/22; D21H 27/002; D21H 27/30; D10B 2505/00

(57) ABSTRACT

A hemp hurd-based nonwoven material comprising a portion of hemp hurd and a portion of at least one other material; wherein the material is a natural or synthetic fiber selected from the group consisting of: polyester, nylon, polyethylene, polypropylene, cotton, flax, jute, ramie, bicomponent fibers, wood pulp, and other fibrous materials; and wherein the nonwoven material comprises between 1% and 99% hemp hurd.

### CROSS-REFERENCE TO RELATED APPLICATIONS

This application is a 371 National Phase Entry of International Patent Application No. PCT/US2019/029426 filed on Apr. 26, 2019, which claims the benefit of U.S. Provisional Patent Application No. 62/663,693 filed on Apr. 27, 2018, with the United States Patent and Trademark Office, the contents of which are incorporated herein by reference in their entirety.

### FIELD OF THE INVENTION

The present application is generally related to nonwoven hemp-based materials having improved absorbent and other mechanical properties relevant for consumer and industrial products, particularly those made from the hurd portion of the hemp plant.

### BACKGROUND OF THE INVENTION

Absorptive pulps are used throughout the world for their physical properties. To make this simple absorptive pulp, trees are converted into pulp which is used to generate absorptive sheets or absorptive biomass. For example, these sheets, or the biomass can be utilized alone, or in combination with additional materials for the absorbent layers of diapers and other absorbent materials. Unfortunately, such use of wood pulp exacts a large toll on the environment. While trees are managed in a sustainable fashion in North America and Europe, this is not the case in many other nations throughout the world. Furthermore, access to trees is limited in some areas, and thus requires shipping or other transportation tools to move either the raw material or finished products.

For example, wood is frequently used in unsustainable numbers in many nations around the world. Typically, this is slash and burn type use, for clearing fields, however illegal logging remains a major issue for many nations in the world. Indeed, such slash and burn or logging is certainly an issue when considering hardwood trees, which often have slow growth rates as compared to softer wood trees. Unfortunately, not all trees with appropriate growth rates are suitable for growth in all areas of the globe.

Similarly, not all grasses and fast growing plants are suitable for growth in all areas. As an alternative to cotton, hemp grows fast and may be able to be grown in areas that are not hospitable to other common cellulosic fiber providers, such as cotton and trees used to produce rayon, making it potentially possible to use locally grown hemp as an ingredient in nonwoven fabrics. For example, a primary use might include an absorbent material for the sound absorbent layers in transportation devices, or as insulation in buildings. Indeed, a significant benefit to such growth is the local propagation of these cellulosic sources, rather than import fibers or finished products from other countries, thereby reducing the energy expenditure and costs associated with shipping raw or finished products far from their ultimate consumption location.

Accordingly, new cellulosic-based materials are needed to enable generation of new nonwoven absorbent materials.

### SUMMARY OF THE INVENTION

A preferred embodiment is directed toward a hemp hurd-based nonwoven that can consist of 100% hemp hurd or blends with other fibers, such as polyester, nylon, polyethylene, polypropylene, cotton, flax, jute, ramie, wood pulp, wool, polylactic acid, bicomponent fibers, and other fibrous materials. In preferred embodiments, the nonwoven comprises between 1%-99% hemp and at least one other cellulosic material at between 99%-1%.

A preferred embodiment is directed toward a hemp hurd-based nonwoven web produced by carding, air-laid, or wet-laid web forming methods.

A preferred embodiment is directed toward a hemp hurd-based nonwoven fabric produced by thermal or adhesive bonding or hydroentangling or needle punching.

A preferred embodiment is directed toward a hemp hurd-based nonwoven material comprising a portion of hemp hurd and a portion of at least one other material; wherein the material is a natural or synthetic fiber selected from the group consisting of: polyester, nylon, polyethylene, polypropylene, cotton, flax, jute, ramie, bicomponent fibers, wood pulp, and other fibrous materials; and wherein the nonwoven material comprises between 1% and 99% hemp hurd. In a preferred embodiment, the hemp hurd-based nonwoven material produced by carding, air-laid, or wet-laid web forming methods. In a further embodiment, the hemp hurd-based nonwoven produced by thermal or adhesive bonding or hydro entangling or needle punching; wherein heat is applied in the production method to melt or soften the at least one other material to form the nonwoven material.

In a further embodiment, the hemp hurd-based nonwoven material formed as a geotextile, blue and green roofs, growing mediums, acoustic insulation, thermal insulation, absorbency, wipes, or interior wall and ceiling panels.

In a further preferred embodiment, the hemp hurd nonwoven material formed with a basis weight of 1 to 1000 grams per square meter.

In a further embodiment, an absorptive material comprising a percentage of hemp hurd and a percentage of an additional vegetative cellulosic material; at least one further material; wherein the at least one further material is a super absorbent polymer. In a preferred embodiment, wherein the super absorptive polymer is suitable to bind the hemp hurd and the additional vegetative cellulosic material. In a preferred embodiment, the absorptive material wherein the percentage of hemp hurd is between 5% and 95% and the percentage of vegetative cellulosic material is between 5% and 95% and the percentage of at least one further material is between 1% and 50%.

In a further embodiment, an absorptive paper material comprising a blend of hemp and wood pulp comprising between 25:75 hemp hurd to wood pulp to 75:25 hemp hurd to wood pulp wherein the blend of hemp and wood pulp is pressed or formed into a sheet of paper. In a further embodiment, the absorptive paper material having a liquid absorptive content of at least 350%.

In a further preferred embodiment, the absorptive paper material wherein the absorptive paper, comprising 25% hurd and 75% cellulosic material, and wherein said absorptive paper is formed through paper making processes and having a basis weight of 1 to 1000 grams per square meter. In a further embodiment, the absorptive paper comprising 75% hurd and 25% cellulosic material. In a further embodiment, the absorptive paper comprising 50% hurd and 50% cellulosic material.

In a further preferred embodiment, an absorptive material comprising a first layer and a second layer wherein said first layer and said second layer have different properties; each of said first layer and said second layer comprising at least 25% of a hemp hurd material and formed as a nonwoven material. In a further embodiment, the absorptive material wherein said first layer comprises a 50:50 blend of hemp hurd to cellulose in said first layer, and wherein said second layer comprises a 25:75 or 75:25 blend of hurd to cellulose; wherein the first layer and second layer absorb liquids at different rates and wherein the first and second layers have different total liquid absorption content. In a preferred embodiment, the absorptive material wherein each of the first layer and second layer comprise a liquid absorption content of greater than 300%.

In a further preferred embodiment, an absorptive material comprising at least one further material selected from a natural or synthetic fiber or combinations thereof. In a further embodiment, wherein said natural or synthetic fibers are combined in a gel-based material, suitable to contain the hemp and one further material. In a further embodiment, wherein the material further comprises a binding element wherein said binding element is an aqueous-based binder.

A method of manufacturing a hurd-based absorptive material comprising: separating hurd from the hemp plant; processing the hurd into suitable sizes for making an absorptive material; and combining the hurd with a second cellulosic material and forming the absorptive material.

In a further embodiment, the absorptive material further comprising wherein the hurd and the second cellulosic material are combined with at least a further material, said at least a further material selected from an aqueous and nonaqueous materials. In a further embodiment, wherein the hurd and second cellulosic material are combined and generated into a wetted pulp consistency and formed as a paper. In a further embodiment, wherein the hurd and second cellulosic material are combined with an aqueous-based gel material to bind the hurd and further material together. In a further embodiment, wherein the combined product is dried to remove excess water, leaving some water percentage in the final product as held by the gel-like material; and wherein the material is pressed into formed shapes, pelleted, or shredded into a fluff-like consistency.

In a further embodiment, the absorptive material further comprising a material absorbed into said absorptive material, wherein said material is selected from the group consisting of an oil, an antimicrobial agent, an antibacterial agent, an antifungal agent, a soap, a moisturizer, or a cleaning agent.

In a further embodiment, a nonwoven hemp material or absorptive material, further comprising a natural or synthetic polymer; wherein said polymer is heated with the hurd and second cellulosic material to form the nonwoven material. In a preferred embodiment, wherein the heating process is an air laying process to form the nonwoven material.

In a further preferred embodiment, a hemp hurd-based nonwoven material comprising a portion of hemp hurd and a portion of at least one other material; wherein the material is a natural or synthetic fiber selected from the group consisting of: polyester, nylon, polyethylene, polypropylene, cotton, flax, jute, ramie, bicomponent fibers, wood pulp, and other fibrous materials; and wherein the nonwoven material comprises between 1% and 99% hemp hurd.

In a further embodiment, the nonwoven material produced by carding, air-laid, or wet-laid web forming methods.

In a further embodiment, the nonwoven material produced by thermal or adhesive bonding or hydro entangling or needle punching; wherein heat is applied in the production method to melt or soften the at least one other material to form the nonwoven material.

In a further embodiment, the nonwoven material formed as a geotextile, blue and green roof, growing medium, acoustic insulation, thermal insulation, absorbency, wipe, or interior wall and ceiling panel.

In a further embodiment, the nonwoven material formed with a basis weight of 1 to 1000 grams per square meter.

In a further preferred embodiment, an absorptive material comprising a percentage of hemp hurd and a percentage of an additional vegetative cellulosic material; and at least one further material; wherein the at least one further material is a super absorbent polymer.

In a further embodiment, the absorptive material wherein the super absorptive polymer is suitable to bind the hemp hurd and the additional vegetative cellulosic material.

In a further embodiment, the absorptive material wherein the percentage of hemp hurd is between 5% and 95% and the percentage of vegetative cellulosic material is between 5% and 95% and the percentage of at least one further material is between 1% and 50%.

In a further preferred embodiment, an absorptive paper material comprising a blend of hemp and wood pulp comprising between 25:75 hemp hurd to wood pulp to 75:25 hemp hurd to wood pulp, wherein the blend of hem and wood pulp is pressed or formed into a sheet of paper.

In a further embodiment, the absorptive material having a liquid absorptive content of at least 350%.

In a further embodiment, the absorptive paper wherein the absorptive paper, comprising 25% hurd and 75% cellulosic material, and wherein said absorptive paper is formed through paper making processes and having a basis weight of 1 to 1000 grams per square meter. In a further embodiment, the absorptive material comprising 75% hurd and 25% cellulosic material. In a further embodiment, the absorptive material comprising 50% hurd and 50% cellulosic material.

In a further preferred embodiment, an absorptive material comprising a first layer and a second layer wherein said first layer and said second layers have different properties; each of said first layer and said second layer comprising at least 25% of a hemp hurd material and formed as a nonwoven material.

In a further embodiment, the absorptive material wherein said first layer comprises a 50:50 blend of hemp hurd to cellulose in said first layer, and wherein said second layer comprises a 25:75 or 75:25 blend of hurd to cellulose; wherein the first layer and second layer absorb liquids at different rates and wherein the first and second layers have different total liquid absorption content.

In a further embodiment, the absorptive material wherein each of the first layer and second layer comprise a liquid absorption content of greater than 300%.

In a further embodiment, the absorptive material comprising at least one further material selected from a natural or synthetic fiber or combinations thereof.

In a further embodiment, the absorptive material wherein said natural or synthetic fibers are combined in a gel-based material, suitable to contain the hemp and one further material.

In a further embodiment, the absorptive material wherein the material further comprises a binding element, wherein said binding element is an aqueous-based binder.

In a further preferred embodiment, a method of manufacturing a hurd-based absorptive material comprising: capturing a portion of hemp stalk comprising hurd material; processing the hurd material into suitable sizes for making an absorptive material by saturating the hurd in a solvent and blending the hurd to form particles; filtering the hurd particles from the solvent; wet laying the hurd particles to form a shape; and baking the shaped hurd particles to form hydrogen bonding between the hurd particles to create the absorptive material.

In a further embodiment, the method further comprising combining the hurd with a second cellulosic material and forming the absorptive material.

In a further embodiment, the method further comprising wherein the hurd and the second cellulosic material are combined with at least a third further material, said at least third further material selected from an aqueous and nonaqueous materials.

In a further embodiment, the method wherein in step (d) the hurd is formed as a paper.

In a further embodiment, the method wherein the third further material is an aqueous-based gel material, and wherein said aqueous-based gel material binds the hurd and the second cellulosic material.

In a further embodiment, the method wherein the combined product is dried to remove excess water, leaving some water percentage in the final product as held by the gel-like material; and wherein the material is pressed into formed shapes, pelleted, or shredded into a fluff-like consistency.

In a further embodiment, the method further comprising imparting a material to be absorbed to said absorptive material wherein said material is selected from the group consisting of an oil, an antimicrobial agent, an antibacterial agent, an antifungal agent, a soap, a detergent, a moisturizer, or a cleaning agent.

In a further embodiment, the method further comprising a natural or synthetic polymer; wherein said polymer is heated with the hurd to form the nonwoven material. In a further embodiment, the method wherein the heating process is an air laying process to form the nonwoven material.

In a further preferred embodiment, a method of manufacturing a hemp hurd-based material comprising: processing a portion of hemp hurd by saturating said hurd in an aqueous solvent; blending said hurd and aqueous solvent to form hurd particles; filtering the aqueous solvent from the hurd particles; wet laying the hurd particles into a mold; baking said hurd particles to form the hemp hurd-based material.

In a further embodiment, the method further comprising a second material; wherein said second material is blended with the aqueous solvent and the hurd.

In a further embodiment, the method further comprising a second material; wherein said second material is added to the filtered hurd particles and blended before wet laying in the mold.

In a further embodiment, the method further comprising a polymer; wherein said polymer is blended with said hurd and wherein the baking process melts the polymer to bind the hurd particles and the polymer together.

### BRIEF DESCRIPTION OF THE FIGURES

FIG. 1 depicts a graph of results of Absorption Testing of Cellulose/Hemp Blends:Absorptive Capacity.

FIG. 2 depicts a graph of Results of Absorption Testing for Cellulose/Hemp Blends:Absorbency Time.

FIG. 3 depicts a process for wet laying hurd materials.

### DETAILED DESCRIPTION OF THE INVENTION

As an alternative to wood pulp, hemp grows faster and may be able to be grown in areas that are not hospitable to trees, making it potentially possible to use locally grown hemp as an absorbent material. For example, a primary use might include an absorbent material for the absorbent cores of diapers in nations around the globe, such as countries having arid or high salt soil that prevent the rapid growth of soft wood trees. Indeed, a significant benefit to such growth is the local propagation of these cellulosic sources rather than importing tree pulp from Europe or North America, thereby reducing the energy expenditure and costs associated with shipping raw or finished products far from their ultimate consumption location.

Indeed, a primary benefit of hemp plants is their ability to grow rapidly in a wide variety of soils and temperatures. For example, hemp grows in inhospitable areas, is resilient to weed ingrowth, does not require the use of pesticides or herbicides and requires little fertilizer or water to thrive. Hemp can also be utilized to assist in clearing or resting a field, between higher energy/nutrient uptake crops, such as soy and corn. Ultimately, hemp functions as a carbon negative plant, making it highly attractive for use. Herein are described new materials and methods of production of a hemp hurd-based nonwoven material having superior properties as compared to existing nonwoven materials.

### Key Characteristics of the Hemp Plant

The average hemp plant grows to a height of between six (6) feet to sixteen (16) feet and matures in approximately seventy (70) to one hundred ten (110) days. A hemp crop has the potential of yielding 3-8 tons of dry stalks per acre per harvest. Hemp has many advantages over other agricultural crops, namely, the plant itself is resilient to weeds, it can be harvested 2-3 times a year and it does not need pesticides or herbicides to flourish. Furthermore, its deep root system means that hemp plants need less nitrogen (fertilizer) and water to flourish, thus allowing them to be grown in a wide variety of conditions.

Hemp, like many dicotyledonous plants contains a phloem and fibers around the phloem. Hemp is no different and contains both a fiber (bast fiber) as well as a woody (hurd) portion around the phloem. Unfortunately, the use of the hurd, or outer protective coating of the hemp plant, has been shunned to date. As the hemp plant grows, the exterior layer is the epidermis, with the bast fibers underneath the exterior layer. Inside the bast fiber is the hurd, which surrounds a hollow core, once the plant is dried. In a given hemp plant, there is significantly more hurd biomass than of fibers.

Hemp fibers are separated from the hurd by mechanical (for example, decortication), or chemical properties, and the fibers can then be used for any fiber materials, including textiles like carpet, yarn, rope, netting, matting, and the like. The hurd, by contrast, has limited uses, and has been only used for processes such as papermaking, particleboards, concrete mixtures, and construction composites, as well as for animal bedding. These are typically low value uses, and thus the hurd becomes almost a disposable, or waste product, thus greatly reducing the economic viability of hemp growth. The ability to manipulate hemp hurd into suitable, higher value commercial products, as described herein, identifies new markets for this highly sustainable product. Accordingly, without use of the hurd, there is significant biomass waste when cultivating Cannabis sativa (hemp).

### Characteristics of Hemp Fiber

The hemp fibers themselves have favorable characteristics besides their use in textiles. They require fewer chemicals to convert the fibers to a “pulp” when compared to trees, and the long fibers can create high quality paper that requires less bleaching than traditional paper made from wood pulp. Less chemical and bleaching usage results in a decrease of chemical byproducts while at the same time producing a superior paper product that does not “yellow” with age. Processing the pulp uses 80-135 gallons of water for two pounds of dry hemp. The overall process is carbon negative removing more CO₂ from the environment than it makes when being produced. The short fibers can also be utilized as packaging material. However, the density of hemp fibers per acre pales in comparison to the total mass of the hurd. Accordingly, it is advantageous to identify processing methods to be able to utilize the hurd as an independent product, thus increasing the profitability and sustainability of hemp, through use of both the fiber and the hurd.

A key difference in the fiber from the hurd is that the fibers are less absorbent than pulp on a wt./wt. basis, most likely due to the presence of lignin in the hemp fibers. Accordingly, while fibers may be easily sourced, their lower growth density per acre and lower absorptive properties mean that they may not be the optimal cellulosic source material as compared to the hurd component. Indeed, this allows for fibers to be used in certain industries where their absorption profile is immaterial and allows for hurd components to be used wherein their increased absorption properties are maximized or optimized for use.

### Processes for Producing Nonwoven Hemp Hurd

Hurd was separated from fibers to generate raw hemp hurd. The hurd was mechanically ground by a processing using water and blending the hurd with rotating blades in the water. The hurd can also be milled, such as with a rod mill, ball milling, compression milling, or other milling processes known to those of ordinary skill in the art. This blending or milling process reduces the size of the hurd particles after even just a few seconds. The hurd was ground until it reached a size of 0.1 micron to 5 mm, depending on the particular utility of the material for use. In certain applications a fine and consistent size particle is advantageous for homogeneity. However, in other applications, randomness of particle size is also suitable. Accordingly, to streamline the process, when a small micron size material is desired, it is advantageous to use screening processes, such as a classification system. Suitable classification systems utilize one or more barriers having pores of a particular size to capture material larger than the pores and allow material smaller than the pores to pass through the material. However, fiber material is often left unclassified, as the various sizes of materials allows for greater intertangling when forming the nonwoven material.

After the hurd is generated into a sufficient size and/or classified, it is combined with one or more of a commercial bleached cellulose wood pulp from cellulosic sources. Those of skill in the art will recognize that cellulosic pulp can be reclaimed from woody materials, from sawmill residue, from recycled paper sources, and other plant-based cellulosic material sources. Several samples were formulated in order to evaluate the properties of each and identify optimized materials for particular uses.

The combination of hemp hurd and the remaining cellulosic material are then combined and pressed into paper-like sheets. Those of skill in the art will recognize that the materials can be formed by standard paper making apparatus or nonwovens wet-laid apparatus.

The combination of hemp hurd and cellulosic material can also be ground into a pulp, dried, and then ground or manipulated into a pulp or loose material. Certain polymers may be advantageously added to form a gel-like material that comprises a percentage of pulp or loose material. Preferably the gel-like material is a binding agent and the composition comprises between 50% and 99% of the cellulosic material and between 1% and 50% of the gel-like material. For example, additions of super absorbent polymers, can be utilized. Those of skill in the art will recognize that there are common superabsorbent polymers made form the polymerization of acrylic acid blended with NaOH, in the presence of an initiator to form a polyacrylic acid sodium salt (sodium polyacrylate). Additionally, others, such as polyacrylamide copolymer, ethylene maleic anhydride copolymer, cross-linked carboxymethylcellulose, polyvinyl alcohol copolymers, cross-linked polyethylene oxide, polyacrylonitrile (starch grafted copolymer).

Various samples were produced of these materials, each having different wet-laid nonwovens made with milled hemp hurd and bleached wood pulp.

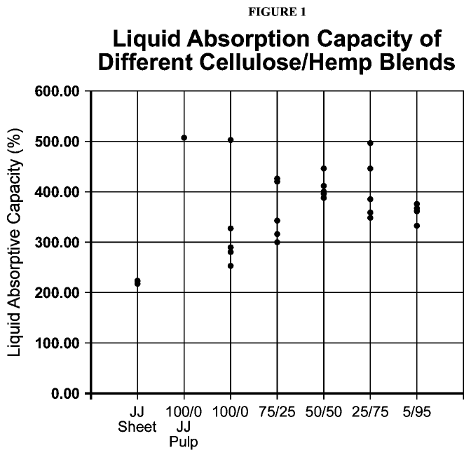

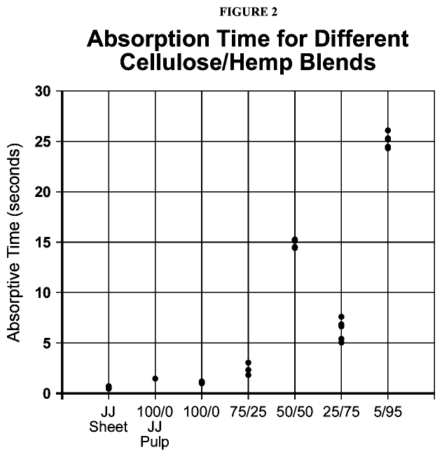

Each of these materials where then tested for absorptive capacity, and the results of such tests are depicted in FIG. 1. Finally, the rate of absorption is also material and the rate of absorption is depicted in FIG. 2.

Tables 1a-1e, as provided below, each detail a ratio of tree pulp to hemp pulp and the corresponding thickness (inches) of each material sheet.

TABLE 1a
Tree Pulp:Hemp Pulp Ratio 100:0

| | Sheet 1 | Sheet 2 | Sheet 3 | Sheet 4 | Sheet 5 | | |
|---|---|---|---|---|---|---|---|
| | 0.192 | 0.106 | 0.144 | 0.214 | 0.155 | | |
| | 0.195 | 0.107 | 0.181 | 0.158 | 0.19 | | |
| | 0.214 | 0.104 | 0.128 | 0.157 | 0.12 | | |
| | 0.118 | 0.115 | 0.119 | 0.196 | 0.12 | | |
| | 0.116 | 0.163 | 0.157 | 0.142 | 0.13 | | |
| Avg. | 0.167 | 0.119 | 0.1458 | 0.1734 | 0.143 | Avg. | 0.14964 |
| SD | 0.04642 | 0.02494 | 0.02450 | 0.03021 | 0.02991 | SD | 0.00891 |

TABLE 1b
Tree Pulp:Hemp Pulp Ratio 75:25

| | Sheet 1 | Sheet 2 | Sheet 3 | Sheet 4 | Sheet 5 | | |
|---|---|---|---|---|---|---|---|
| | 0.259 | 0.204 | 0.214 | 0.247 | 0.235 | | |
| | 0.215 | 0.245 | 0.177 | 0.235 | 0.226 | | |
| | 0.202 | 0.228 | 0.19 | 0.228 | 0.228 | | |
| | 0.222 | 0.219 | 0.173 | 0.217 | 0.225 | | |
| | 0.261 | 0.278 | 0.226 | 0.165 | 0.226 | | |
| Avg. | 0.2318 | 0.2348 | 0.196 | 0.2184 | 0.228 | Avg. | 0.2218 |
| SD | 0.02673 | 0.02834 | 0.02318 | 0.03177 | 0.00406 | SD | 0.01093 |

TABLE 1c
Tree Pulp:Hemp Pulp Ratio 50:50

| | Sheet 1 | Sheet 2 | Sheet 3 | Sheet 4 | Sheet 5 | | |
|---|---|---|---|---|---|---|---|
| | 0.28 | 0.33 | 0.292 | 0.245 | | | |
| | 0.225 | 0.32 | 0.341 | 0.225 | N/A | | |
| | 0.224 | 0.269 | 0.239 | 0.21 | | | |
| | 0.245 | 0.27 | 0.18 | 0.225 | | | |
| | 0.248 | 0.409 | 0.176 | 0.278 | | | |
| Avg. | 0.2444 | 0.3196 | 0.2456 | 0.2366 | N/A | Avg. | 0.26155 |
| SD | 0.02276 | 0.05727 | 0.07149 | 0.02627 | N/A | SD | 0.02377 |

TABLE 1d
Tree Pulp:Hemp Pulp Ratio 25:75

| | Sheet 1 | Sheet 2 | Sheet 3 | Sheet 4 | Sheet 5 | | |
|---|---|---|---|---|---|---|---|
| | 0.35 | 0.228 | 0.176 | 0.25 | 0.324 | | |
| | 0.255 | 0.226 | 0.118 | 0.162 | 0.297 | | |
| | 0.25 | 0.273 | 0.207 | 0.206 | 0.325 | | |
| | 0.226 | 0.23 | 0.227 | 0.25 | 0.215 | | |
| | 0.244 | 0.233 | 0.226 | 0.154 | 0.225 | | |
| Avg. | 0.265 | 0.238 | 0.1908 | 0.2044 | 0.2772 | Avg. | 0.23508 |
| SD | 0.04876 | 0.01973 | 0.04563 | 0.04609 | 0.05352 | SD | 0.01324 |

TABLE 1e
Tree Pulp:Hemp Pulp Ratio 5:95

| | Sheet 1 | Sheet 2 | Sheet 3 | Sheet 4 | Sheet 5 | | |
|---|---|---|---|---|---|---|---|
| | 0.233 | 0.165 | 0.293 | 0.24 | 0.185 | | |
| | 0.221 | 0.164 | 0.225 | 0.22 | 0.225 | | |
| | 0.158 | 0.226 | 0.248 | 0.23 | 0.126 | | |
| | 0.161 | 0.167 | 0.196 | 0.228 | 0.122 | | |
| | 0.225 | 0.211 | 0.25 | 0.226 | 0.192 | | |
| Avg. | 0.1996 | 0.1866 | 0.2424 | 0.2288 | 0.17 | Avg. | 0.20548 |
| SD | 0.03687 | 0.02961 | 0.03572 | 0.00729 | 0.04464 | SD | 0.01420 |

We then took these formulated samples and tested their ability to absorb fluids as compared to a known brand sheet, with regard to the time to absorb (Table 2), and the total volume of fluids (Table 3). For all tests below, each sheet was tested five times for the Liquid absorption time measured the time a material takes to sink in a water bath, with reflects upon the rate of absorbency. In Table 3, each sheet was tested five times for the Liquid Absorption Content (LAC), which was calculated by subtracting the dry weight from the wet weight, dividing that number by the dry weight, and then multiplying by 100%.

TABLE 2
Liquid Absorption Time

| | Dry | Sinking | | Dry | Sinking |
|---|---|---|---|---|---|
| | Weight (g) | Time (min) | | Weight (g) | Time (min) |
| J&J Sheet | | | 100/0 Sheet | | |
| Average | 5.03 | 0.81 | Average | 5.05 | 1.34 |
| Std Dev | 5.03 | 0.81 | Std Dev | 0.02 | 0.09 |
| 75/25 Sheet | | | 50/50 Sheet | | |
| Average | 5.00 | 2.88 | Average | 5.03 | 14.99 |
| Std Dev | 0.02 | 0.56 | Std Dev | 0.03 | 0.41 |
| 25/75 Sheet | | | 95/5 Sheet | | |
| Average | 5.03 | 6.51 | Average | 5.03 | 25.08 |
| Std Dev | 0.04 | 1.05 | Std Dev | 0.02 | 0.72 |

Totals for liquid absorption for the above tests are provided in the below Table 3.

TABLE 3

| Liquid Absorption | Average | Std Dev |
|---|---|---|
| Content | (%) | (%) |
| Brand | 218.51 | 2.56 |
| 100/0 | 328.88 | 99.40 |
| 75/25 | 359.36 | 58.61 |
| 50/50 | 406.84 | 22.82 |
| 25/75 | 405.34 | 62.75 |
| 5/95 | 252.52 | 20.44 |

It is important to evaluate both the amount of liquid absorbed, but also the time for total liquid absorption. We measured the total time it takes to allow the material to sink within a water bath. This approximates the speed at which the material can absorb moisture. Accordingly, a material with a lower sinking time absorbs the water at a faster rate, thus allowing saturation to be rapidly reached and thus allow the material to sink. Those with a slower sinking time are taking longer to reach saturation and thus will sink slower.

Sinking rate, or by extension, absorption rate is not a simple, faster is better analysis, instead it allows for evaluation of each material for appropriate properties. Certain materials may be superior when they have a fast absorption rate, thus quickly pulling liquids into the material. In certain times, the speed at which the liquid is absorbed is critical to containing or collecting a contaminant. Furthermore, faster rate of absorption may also allow for creation of a current, from the liquid into the absorptive material, thus aiding in drawing the liquid into the absorptive material, even where the liquid is positioned in a hard to reach spot, or one that holds the liquid in place.

Alternatively, a slow absorbing material may be advantageous for situations where some moisture is necessary, or where the conditions necessitate a slow removal of a liquid, for example, to reduce the generation of a current from the liquid into the absorptive material, so as to not disturb some secondary material.

Totals for the time for absorption are provided in the below Table 4.

TABLE 4

| | Average (min) | Std Dev (min) |
|---|---|---|
| Brand | 0.81 | 0.09 |
| 100/0 | 1.34 | 0.09 |
| 75/25 | 2.88 | 0.56 |
| 50/50 | 14.99 | 0.41 |
| 25/75 | 6.51 | 1.05 |
| 5/95 | 25.08 | 0.72 |

### Outcomes of Testing of Nonwoven Hurd

Accordingly, we can summarize that materials using a blend of hemp and wood pulp preferably between a 50/50 blend of wood pulp to hurd, and to 25/75 wood pulp to hurd, perform best in absorptive properties. Accordingly, a material using such a blend would have advantages over other available materials for absorbing liquids. Interestingly, the 50:50 blend and the 5:95 blends had the slowest rate of absorption. Accordingly, these materials may be suitable for many of the applications provided herein.

Based on all tests, a blend of 50:50 appears best for absorption when you need a material that slowly absorbs material. By contrast a 25:75 material or a 75:25 material is best for absorption and fast rate of absorption, with the 25:75 absorbing slightly more but at a slightly slower rate than the 75:25 material. Those of skill in the art will know how to best utilize the properties of such materials.

In certain embodiments, it is envisioned to manufacture a material from 25% hurd and 75% cellulosic material.

In certain embodiments it is envisioned to manufacture a material from 25% hurd and 75% cellulosic material.

In certain embodiments it is envisioned to manufacture a material from 50% hurd and 50% cellulosic material.

In certain preferred embodiments, a material may be manufactured in layers, with a first layer having a different concentration of hurd than another layer. For example, a material may have a 50:50 blend in a top layer, allowing for slow absorption of liquids, and a bottom layer having the ability to quickly absorb materials with a different concentration of hurd:cellulosic material. A liquid contacting the bottom layer will be quickly absorbed by the bottom layer first, and then slowly absorbed into the top layer over time. The top and bottom layers can be swapped for particular applications as known to those of skill in the art.

Therefore, a proposed embodiment comprises manufacturing of a hemp-based nonwoven material comprising between 25% and 75% hemp hurd and 75% to 25% cellulose.

A preferred embodiment is a hemp-based nonwoven material comprising 25% hemp hurd and 75% of at least one further material selected from a natural or synthetic fiber wherein said fibers are combined in a gel-based material, suitable to contain the hemp and one further material. Alternatively, the hemp hurd and further material are made into a paper-like material.

A further preferred embodiment is directed toward a nonwoven material comprising 50% hemp hurd and 50% of at least one further material selected from a natural or synthetic fiber wherein said materials are combined and formed as a paper product. Alternatively, the materials are combined with a gel-like product to contain hurd and one further material in a pulp-like composition.

A further preferred embodiment is directed toward a nonwoven material comprising 75% hemp hurd and 25% of at least one cellulosic material.

A further preferred embodiment is directed toward a nonwoven material comprising 95% hemp hurd and 5% of at least one further material selected from a natural or synthetic material, preferably a cellulosic or absorptive material.

The materials are preferably formed into sheets, for example through ordinary paper making processes, by wetting the materials, and pressing them to dry.

Alternatively, the hurd and further materials are combined with at least a further material, for example a super absorbent polymer or a gel-based material. Preferably the hurd and the further material are generated in a wetted pulp consistency and combined. In some embodiments, the materials are combined with an aqueous-based gel material to bind the hurd and further material together. The finished product can be dried to remove excess water, leaving some water percentage in the final product as held by the gel-like material, typically less than 25% water. Finally, the material can be pressed into formed shapes or it can be shredded into a fluff-like consistency or formed into beads or pellets. This material can be then added as fill, sprayed as a filler, or in other means as known to those of skill in the art. For example, such materials, can be advantageously utilized for diapers, sanitary products, or other embodiments where a material is needed for liquid absorption.

The hurd-based nonwoven material, because of the entanglement of the hurd fibers together has incredible strength, as compared to a standard paper product, yet retains the significant absorbency of the hurd material, and is disposable and biodegradable. However, this can be further modified and strengthened by incorporation of certain polymers. Therefore, in some embodiments, it may be advantageous to form the nonwoven material using various air lay or other heating processes that combine the hurd with a polymer to form the nonwoven material, having additional tensile strength, but with the absorptive properties of the hurd fibers. These processes are formed under an application of heat, typically between 100° C. and 200° C., to allow for the polymer to melt and to combine with the hurd material.

Indeed, the use of certain biodegradable polymer, such as PLA, allow for a product that has tremendous strength yet retains its biodegradable nature. PLA, as known to those of ordinary skill in the art is derived from renewable biomass and has a melting point of between 150-160° C. Accordingly, as with any optimization, the specific polymer (or polyester as PLA is technically a polyester), will necessitate the specific binding temperature of the nonwoven material.

In certain embodiment, the nonwoven hemp hurd materials are manufactured in such a percentage with additional natural or synthetic fibers or pulp so as to generate significant structural, mechanical, and performance improvements. For example, such a material may be useable not only for its purely absorptive properties with liquids, but such material also provides excellent sound absorbing or dampening properties. For example, such materials are currently used for acoustic wall or ceiling tiles in office spaces, home spaces, automotive, and industrial applications. Such materials, therefore, would be suitable for replacement in such spaces, but also for generating portable paneling materials. Currently a blend of kenaf and bicomponent fibers is used to create an acoustical fabric for automotive applications. We can exchange the kenaf with hemp hurd particles and obtain similar properties in terms of thickness, basis weight, strength, and acoustical absorption while using a sustainable and reproducible material. However, these materials are often lighter in weight but maintain the same or even greater strength that the kenaf fibers.

A further preferred embodiment is directed toward a nonwoven material comprising a portion of hemp hurd and a portion of at least one further material selected from a natural or synthetic polymers wherein said polymers are combined with the hurd in a nonwoven processing, such as an air-laid process and bonded through air bonding at 150° C. for two minutes.

Thus, for example, the further material is a natural or synthetic fiber, with natural fibers selected from the group consisting of flax, sisal, jute, coconut, grass, straw, wool, and the like. Synthetic fibers include fibers having a high or low melt temperature. Relatively high melt temperature fibers include polyethylene fibers, polypropylene fibers, bicomponent fibers, polyester fibers, polycarbonate fibers, polyamide fibers, rayon fibers, polyvinyl alcohol fibers, polyvinyl acetate fibers, polyacrylonitrile fibers, polylactic acid fibers, carbon fibers, and the like. Preferably, the relatively high melt temperature fibers are polyester fibers, particularly polyethylene terephthalate fibers, or olefin fibers or bicomponent fibers. The fibers may be virgin fibers, fibers obtained as recyclable products from textile, and/or carpet manufacture, or any other source. The relatively high melt temperature fibers may be crimped, as disclosed in U.S. Pat. No. 5,779,782, herein incorporated by reference. The high melt temperature fibers may comprise up to 80 weight % of total synthetic fibers, more preferably up to 60 weight %, and most preferably from 0 weight % to 50 weight %, with each percentage from 0 weight % to 80 weight % considered as individually disclosed herein.

With regard to low melt synthetic fibers, it is preferable that the core be polyester and the sheath be polyolefin, preferably polyethylene or polypropylene (including copolymeric polyethylene polymers and polypropylene polymers), and most preferably polyethylene homo- or copolymers. While the terms “core” and “sheath” are used to describe the bicomponent fibers herein, these terms also include bicomponent fibers having an incomplete sheath, including bicomponent fibers where a strand of high melt temperature polymer abuts, continuously or discontinuously, a strand of low melt temperature polymer. The important consideration is that the bicomponent fiber be an integral fiber containing both polymers, regardless of physical arrangement, so long as the low temperature polymer is not completely surrounded or obscured by the high temperature polymer. By the term “high melt temperature” is meant a melt temperature such that the core of the fiber does not melt and thus lose its integrity under mat consolidation conditions. Some softening of the core is allowable. By “low melt temperature” is meant a temperature at which the sheath polymer softens and/or melts to the degree necessary to bind the natural fibers and other constituents of the mat together. The preferred bicomponent fibers are bicomponent fibers available from Leigh Fibers, having a low temperature sheath melting at about 110° C., and a core which melts at 500° F. (260° C.) or higher. However, other bicomponent fibers are commercially available and useful as well.

Core/sheath bicomponent fibers may be supplied with a concentric or eccentric core; the latter, as well as noncore/sheath bicomponent fibers, e.g. those having a side-by-side morphology, are useful in providing a product with greater loft while employing the same amounts of raw materials. Bicomponent fibers with polyester core and sheaths of polyethylene, linear low density polyethylene, and copolyester are available, as are also bicomponent fibers with a polypropylene core and polyethylene sheath. Bicomponent fibers with a polyamide core are also available. Copolyester sheaths generally have melting points in the range of 130° C. to 220° C., while polyethylene sheaths range from about 90° C. to 130° C. Polypropylene in core products generally melts at about 175° C., while polyester cores may melt from 200° C. to 250° C. or higher. Bicomponent polyamide fibers are also available with a polyamide 6,6 core (m.p. 260° C.) and polyamide 6 sheath (m.p. 220° C.). Core/sheath ratios of bicomponent fibers may range from 20:80 to 80:20 by weight, more preferably 60:40 to 40:60, and generally about 50:50.

The melting point of a sheath polymer or core polymer is dependent, of course, on its chemical makeup, and partially dependent on its molecular weight. Thus, lower molecular weight and to some degree oligomeric products tend to have lower melting points, while incorporation of comonomers, such as 1-butene and 1-octene in polyethylene, generally also lower the melting point. For “homopolyesters,” polyethylene terephthalate (PET) has a lower melting point than polyethylene naphthalate (PEN). Many combinations are possible, and commercially available. Bicomponent fibers are also available from Fiber Innovation Technology, Inc., Johnson City, IN, and ES FiberVisions, Inc., Athens, GA. The bicomponent fibers comprise minimally 5 weight % of the total weight of all synthetic fibers, preferably minimally 10 weight %, more preferably minimally 15 weight %, and may comprise any weight percentage up to 100 weight % of total synthetic fibers, each percentage between 5 weight % and 100 weight % considered herein as individually disclosed. It is particularly preferred that the bicomponent fibers comprise from 60%-100% of the total synthetic fiber content, more preferably 70%-100%, yet more preferably 80%-100%, and most preferably 90%-100%. Most particularly, all synthetic fibers are bicomponent fibers.

The synthetic fiber component may also comprise conventional synthetic fibers other than bicomponent fibers. Such fibers may include fibers of relatively low melt temperature, i.e., which will soften appreciably and/or melt under mat consolidation temperatures, and those of relatively high melt temperature, i.e., which will remain integral under mat consolidation conditions. The terms “relatively” low and “relatively” high are used to describe the melt temperatures of the nonbicomponent fibers, since melting of these fibers is dependent upon the mat consolidation temperature which is in turn dependent upon the melting point of the low melt temperature portion of the fibers. A “relatively low” melt temperature fiber will exhibit softening and/or melting during consolidation, while “relatively high” melt temperature fibers will exhibit no melting. Thus, the relatively low melt temperature fibers may assist in mat bonding, with greater assistance in this respect as the consolidation temperature increases, while relatively high temperature fibers generally produce no increase in binding, but an increase in tensile strength of the mat due to these fibers retaining their integrity during consolidation.

Relatively low melt temperature fibers are preferably polyolefin homopolymers and copolymers, for example polyethylene fibers and polypropylene fibers, which are preferred. The relatively low melt synthetic fibers may comprise the remainder of the nonbicomponent fibers, but preferably constitute no more than 95% by weight of the total synthetic fiber content, more preferably less than 90% by weight, and most preferably about 85% by weight when both bicomponent and nonbicomponent fibers are employed.

The particular core and fiber utilized is important for the temperature at which the fibers are bound and spun. The preferred method utilizes an air bonding process that includes a 150° C. temperature for two minutes. Accordingly, low melt temperature fibers, as described above, having an outer or inner core that will melt or soften at below 150° C. within two minutes' time, will result in increased binding of the fibers to the hemp material.

By contrast, fibers that have a higher melt temperature than 150° C. will respond differently than the low melt temperatures. For example, use of a high melt core, where the core will not soften or melt at 150° C. for two minutes, but an outer sheath that will soften in the two minutes at 150° C., will allow for a moderate combination of materials.

Those of skill in the art will know how to select a suitable fiber-based on the needs to the material and its intended purposes. Furthermore, those of skill in the art can modify the melt temperature for thermal bonding the nonwoven material, for example modifying the temperature up or down. Other properties may increase or decrease the time of the heating process.

### Formation of Nonwoven Hemp Hurd Materials

Hemp hurd, in the form of dew retted stalks, can also be converted into products without the need for other cellulosic additives. Dew retted stalks can be processed in the same manner as the hemp hurd, but due to the presence of some fibers in the stalks, they do not need other cellulosic material added to them to create strength through hydrogen bonding, although if increased strength is desired, other materials can be added. Additionally, other fibrous materials could be added as well.

### Hemp Hurd Planting Pots

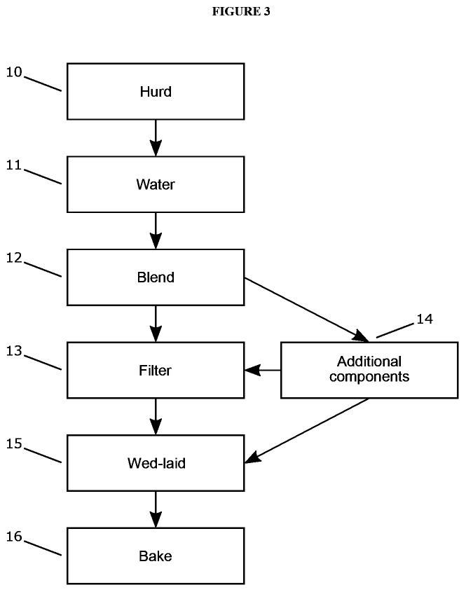

The process below is generally detailed in FIG. 3. Dew retted hemp stalks (hurd) (10) were placed into a commercial Waring blender, water (11) was added to the point at which the stalks were fully immersed in water, and the stalks were ground down through the actions of the blender (12). The resulting particles, approximately 0.5-1.0 mm in length, and water were then filtered (13) to separate the water from the hurd particles. The damp particles (15) were placed into 3D printed plastic molds and placed into an oven at temperatures ranging from 50° C. to 120° C. (16) until the hurd had dried and hydrogen bonded to form solid parts, at which point they were removed from the plastic molds. An additional component (14) can be added to the above process after blending (12), which is then either filtered (13), or directly wet-laid (15).

Molds were based on Jiffy Seed Starting Greenhouse trays made from peat. Ten hemp hurd pots and 10 Jiffy peat pots were planted filled with damp Natural Beginnings™ Seed Starting Mix from Gardens Alive, a coir-based soilless seed starting mix. Each pot was filled with 20 grams of mix, with a 1-centimeter hole placed in the center of the soil. A spinach seed (Bloomsdale from Rohrer Seeds) was placed in each hole in each pot and covered with 1 centimeter of starting mix. An alternating pattern of pots was placed in a typical seed starting tray, with the tray placed under fluorescent glow lamps. All pots were watered every few days. After 10 days two of each pot types had seedlings started. The seedlings had similar germination and growing rates. After several weeks it was noticed that the hemp hurd pots were damper and more fragile than the peat pots, indicating that they retained more moisture than the peat pots. After an additional 14 days, the hurd pots began showing fractures, indicating an increased rate of decomposition, as compared to the peat pots, thus allowing the plant roots to expand into the surrounding environment at a faster rate, once the plants and pots had been planted into larger permanent containers or gardens.

Table 5 below gives the weight of the different pots. The hemp hurd pots were slightly lighter in weight than the peat pots, but not significantly so.

TABLE 5

| | Hurd pots | Peat pots |
|---|---|---|
| Weight | 3.44 | 3.83 |
| (grams) | 4.31 | 3.71 |
| | 3.19 | 3.11 |
| | 3.60 | 3.19 |
| | 2.68 | 3.81 |
| | 2.10 | 3.10 |
| | 3.33 | 3.61 |
| | 2.84 | 3.52 |
| | 3.62 | 3.71 |
| | 3.40 | 3.32 |
| Average | 3.251 | 3.491 |
| Std Dev | 0.60 | 0.29 |

### Applications for Nonwoven Hemp Hurd

The nonwoven hemp hurd materials as described herein show advantages for absorption of liquids over a generic material then potential applications focus on spill clean ups like mop head replacements or countertop cleaners and other wipe applications. Because of the tensile strength of the material, and the dramatic absorptive properties, the nonwoven hurd materials are significant improvements over standard wood pulp-based absorbent materials.

With regard to commercial embodiments, the materials and the properties of the materials are suitable for replacing certain wood pulp-based materials, because of their improved properties, as compared to wood pulp. For example, some specific potential examples are:

WET OR DRY MOP PADS: Replaceable absorbent pad for a wet or dry mop. The absorbent hemp pad is wrapped around the mop head and can be disposed of and replaced in the same manner as dry or wet dusting pads. These would be possibly ecofriendly, absorbent, retain liquid, partially to biodegradable depending on whether or not it is blended and what it is blended with, nontoxic, and lightweight.

COUNTERTOP SPILL CLEANER: Device used to quickly soak up spills that occur on a countertop or floor. This would be “one and done,” partially to fully biodegradable, and possibly ecofriendly. Because of the increased absorbency, hemp-based materials show advantages over the common paper towel.

ACOUSTIC WALL AND CEILING TILES: Provide for an efficient way to utilize the nonwoven hurd material for its ability to limit acoustic spread. Thus, manufacture of individual wall tiles that can adjust the acoustics in a room can be made from the hemp hurd materials. The tiles can be pressed into different patterns and arranged to meet special limitations. This will reduce sound, is ecofriendly, durable, and lightweight.

Furthermore, the material may simply be utilized for its insulative properties, as a replacement for paper-based or fiberglass insulations. These insulative materials are easily impregnated with fire resistant materials or mold resistance materials, as depending on the particular issues and uses of the material. Furthermore, the material may replace components, such as animal down feathers, as a natural insulative material for home goods and apparel.

CLEANING WIPES: Wipes to be used for cleaning, make up removal, skin exfoliation, or other similar tasks. Depending on the percentages of materials, such wipes can be more or less absorptive, and made with fine or course particles, thus generating a fine/soft material or one that has grain and texture.

HEAVY METAL AND ORGANIC COMPOUND ABSORPTIVE FABRICS: These fabrics can be used in conjunction with fly ash and other similar materials to absorb heavy metal and undesirable organic compounds from contaminated water.

Because of the strong absorptive properties of the material, geotextiles that require absorption would be advantageous. Thus, in areas where water is needed, the material can be saturated with water and allow release of the water over time, thus providing an efficient moisture source. Thus, planting of seeds or crop materials can be improved by this material which will hold water but also degrade in time.

BLUE ROOF FABRIC: Hemp-based fabrics and materials could be used to absorb water during rain events and slowly release the water to the storm water system to avoid overloading the storm water system. Because of the rate of absorption of the hurd-based nonwoven material, water can be rapidly absorbed to prevent immediate runoff.

We also envision use these materials for water collection projects, to replace common landscape hay barriers and the like. Furthermore, these materials may be advantageous for oil or other hazardous material absorption, as well as be used as a component of environmentally friendly roofing materials.

Hemp-based materials are also highly suitable as a grown medium or use in biodegradable planting containers. For example, materials can be wetted and the absorptive properties allow for plants to take water from the materials at a controlled rate, thus providing a suitable growth medium. Certain coconut-based fibers are used for such purpose at the moment, and the hemp material may be advantageous as it absorbs more material and thus may allow for longer duration between adding water to the material. Combinations of materials, of course, may be optimal for particular conditions.

Hemp-based materials are also suitable to be impregnated with natural or synthetic materials to provide additional uses. In certain industries, it may be suitable to impart the nonwoven material with soaps or cleaning agent, whether for cosmetic use, antibacterial or antimicrobial use, or for general cleaning. The high absorptive nature of the material lends itself well toward impregnating the material, well below its saturation point, and allowing for use of the material and release of some of the impregnated material to a second surface.

One superior feature of the hemp product is that it can be impregnated with natural oils to impart natural antimicrobial properties. One such use is application of an oil comprising antifungal properties, wherein the impregnated within the material will aid in preventing the growth of mold or mildew when using these products in areas likely to grown mold or mildew, such as in areas of high moisture.

Indeed, those of ordinary skill in the art will recognize that the hemp hurd are able to be easily dipped into a solvent and the material will be absorbed by the fibers. Similarly, a second fiber, either a natural or synthetic material, can also absorb or bind to a solvent material. For example, by impregnating the hurd with another material, a portion of that material will be maintained by the hurd. Some of these materials may also bind to the natural fiber, or otherwise bind with the synthetic fibers. Some oils provide antimicrobial properties, yet others may have a pleasant aroma or may make the material more hydrophobic, while others may make the material more attractive to dust or dirt particles, for example for a cleaning material.

Therefore, it is advantageous that the hemp-based nonwoven material comprises a further natural or synthetic material to impart a further property to the nonwoven material. For example, wherein the synthetic material is a chemical suitable for imparting fire resistance, antimicrobial, antibacterial, increasing hydrophobicity of the hurd to prevent moisture, or imparted with a suitable cleaning agent or cosmetic agent.

Because of the different materials, the hemp material may interact with one material at a greater rate than a second fiber of the nonwoven material. Accordingly, in certain embodiments, wherein the hemp hurd has a different absorbent property than a second material, and wherein the hemp hurd is impregnated with a first compound and the second material is impregnated with a second compound.

For example, the hemp material may be generated in an aqueous solvent and used as a wipe, to be used for cleaning, make up removal, skin exfoliation, or other similar tasks. The length and natural strength of the hemp hurd, when laid in nonwoven materials provide natural strength thus making such materials highly suitable for cleaning products, even when the hurd are wet. Thus, the material retains 50%, 75%, 90%, and 95% of its tensile strength even when wet with an aqueous solvent. For nonaqueous solvents, the tensile strength may be retained when the corresponding second material in the nonwoven material is not dissolved by the nonaqueous solvent.

At the same time, processes can be utilized to make both rough surface nonwoven materials, which are suitable for grit removal or for exfoliation, or to make soft and smooth materials, suitable for gentle application to the skin. Accordingly, materials such as salicylic acid, lactic acid for cleaning, other gentle soaps, and detergents, as well as vitamin C, and other antioxidant materials can be advantageously added to or impregnated into the materials. In certain embodiments, a portion of grit, natural grit such as salt, sugar, or husk or seed fragments can be adhered to the nonwoven material to form nonwoven materials for exfoliating skin or otherwise gently abrasive.

Heavy metal and organic compound absorptive fabrics can be used in conjunction with fly ash and other similar materials to absorb heavy metal and undesirable organic compounds from contaminated water.

Those of skill in the art will recognize that numerous suitable oils including those for aesthetic purposes, essential oils, and oils for imparting antimicrobial or antibacterial properties can be easily provided. Binding agents, while not necessary for most components, may be further included as appropriate.

What is claimed is:

1. A hemp hurd based nonwoven material comprising a portion of hemp hurd and a portion of at least one other material; wherein the at least one other material is a natural or synthetic fiber selected from the group consisting of: polyester, nylon, polyethylene, polypropylene, cotton, flax, jute, ramie, bicomponent fibers, wood pulp, and other fibrous materials; and wherein the nonwoven material comprises between 1% and 99% hemp hurd.

2. (canceled)

3. The hemp hurd based nonwoven material of claim 1 produced by thermal or adhesive bonding or hydro entangling or needle punching; wherein heat is applied in the production method to melt or soften the at least one other material to form the nonwoven material.

4. (canceled)

5. The hemp hurd nonwoven material of claim 1, formed with a basis weight of 1 to 1000 grams per square meter.

6. The hemp hurd nonwoven material of claim 1 further comprising a super absorbent polymer.

7. The hemp hurd nonwoven material of claim 1 wherein the super absorptive polymer is suitable to bind the hemp hurd and the at least one other material.

8. (canceled)

9. (canceled)

10. (canceled)

11. (canceled)

12. (canceled)

13. (canceled)

14. An absorptive material comprising a first layer and a second layer, wherein said first layer and said second layers have different properties; each of said first layer and said second layer comprising at least 25% of a hemp hurd material and formed as a nonwoven material.

15. The absorptive material of claim 14, wherein said first layer comprises a 50:50 blend of hemp hurd to cellulose in said first layer, and wherein said second layer comprises a 25:75 or 75:25 blend of hurd to cellulose; wherein the first layer and second layer absorb liquids at different rates and wherein the first and second layers have different total liquid absorption content.

16. The absorptive material of claim 14 wherein each of the first layer and second layer comprise a liquid absorption content of greater than 300%.

17. The absorptive material of claim 14, comprising at least one further material selected from a natural or synthetic fiber or combinations thereof.

18. The absorptive material of claim 17, wherein said natural or synthetic fibers are combined in a gel-based material, suitable to contain the hemp and one further material.

19. The nonwoven material of claim 17, wherein the material further comprises a binding element, wherein said binding element is an aqueous based binder.

20. A method of manufacturing a hurd based absorptive material comprising:
a. capturing a portion of hemp stalk comprising hurd material;
b. processing the hurd material into suitable sizes for making an absorptive material by saturating the hurd in a solvent and blending the hurd to form particles;
c. filtering the hurd particles from the solvent;
d. wet laying the hurd particles to form a shape; and
e. baking the shaped hurd particles to form hydrogen bonding between the hurd particles to create the absorptive material.

21. The method of claim 20, further comprising combining the hurd with a second cellulosic material and forming the absorptive material.

22. The method of claim 21, further comprising wherein the hurd and the second cellulosic material are combined with at least a third further material, said at least third further material selected from an aqueous and nonaqueous materials.

23. The method of claim 21, wherein in step (d) the hurd is formed as a paper.

24. The method of claim 22, wherein the third further material is an aqueous based gel material, and wherein said aqueous based gel material binds the hurd and the second cellulosic material.

25. The method of claim 24, wherein the combined product is dried to remove excess water, leaving some water percentage in the final product as held by the gel like material; and wherein the material is pressed into formed shapes, pelleted, or shredded into a fluff like consistency.

26. The method of claim 20, further comprising imparting a material to be absorbed to said absorptive material, wherein said material is selected from the group consisting of an oil, an antimicrobial agent, an antibacterial agent, an antifungal agent, a soap, a detergent, a moisturizer, or a cleaning agent.

27. The method of claim 20, further comprising a natural or synthetic polymer; wherein said polymer is heated with the hurd to form the nonwoven material.

28. The method of claim 27, wherein the heating process is an air laying process to form the nonwoven material.

29. (canceled)

30. (canceled)

31. (canceled)

32. (canceled)
